(19) United States
(12) Patent Application Publication
(10) Pub. No.: US 2024/0280224 A1
(43) Pub. Date: Aug. 22, 2024

(54) LARGE COMPOSITE CYLINDER BOSS DESIGN

(71) Applicants: L’AIR LIQUIDE, SOCIETE ANONYME POUR L’ETUDE ET L’EXPLOITATION DES PROCEDES GEORGES CLAUDE, PARIS (FR); COVESS NV, HASSELT (BE)

(72) Inventors: Tony VANSWIJGENHOVEN, HASSELT (BE); Philippe PAPIN, JOUY-EN-JOSAS (FR)

(21) Appl. No.: 18/567,645

(22) PCT Filed: Jun. 3, 2022
(86) PCT No.: PCT/EP2022/065262

§ 371 Date: Dec. 6, 2023

(30) Foreign Application Priority Data
Jun. 7, 2021 (EP) 21305773.0

(51) Int. Cl. F17C 13/06; F17C 1/06; F17C 1/10

(52) U.S. Cl. CPC F17C 13/06; F17C 1/06; F17C 1/10; F17C 2201/0109; F17C 2205/0305; F17C 2260/053

(57) ABSTRACT

A fibre composite cylindrical tank containing a pressurized fluid sealed by a boss seal, has at least one opening with diameter D0, and having an inner surface, sealed by a boss seal, wherein the boss seal includes a first boss section with diameter D1 larger than the opening diameter D0 and second boss section of diameter D0 equal to the opening diameter D0, and wherein the first section is leaned against the inner surface of the tank by the pressurized fluid, the second section fits the opening and a gasket of diameter D2 larger than the opening diameter D0 is placed on the second boss section.

### TECHNICAL FIELD

The invention relates to pressurized fluid storage tanks.

More specifically, the invention relates to a fibre composite cylindrical tank containing a pressurized fluid sealed by a boss seal.

### STATE OF THE ART

Metallic cylindrical tanks (or vessels) containing pressurized fluids are known in the art.

But the fluid content in the metallic tank can be aggressive (i.e. corrosion) and may crack or weaken the tank's structure and welds.

Cylindrical fibre composite tanks are also known in the art.

Compared to metallic tanks, cylindrical fibre composite tanks are lightweight, have a greater storage capacity due to its thinness, are more likely to be corrosion and fatigue resistant and need less maintenance.

There is a need for these tanks to have at least one opening, used to insert and remove devices such as gauges, pipes or catalysers. As these tanks are pressurized and have at least one large opening (bigger than 50 mm), a structural issue can develop rapidly.

Having a fibre composite structure will not match with heavy metal equipment to seal the opening as it may lead to structural failure.

### DESCRIPTION

There is a need for an apparatus of a cylindrical tank having at least one opening to be corrosion-resistant, and being sealed by an equipment that is light and resistant to pressure and corrosion, and having a longer lifetime.

To this end, the invention relates to a fibre composite cylindrical tank for containing a fluid, having at least one opening with diameter D₀, and having an inner surface A₁, sealed by a boss seal, characterised in that the boss seal comprises:
a first boss section with diameter D₁ larger than the opening diameter D₀ and
a second boss section of diameter D₀ equal to the opening diameter D₀, and that
the first section is leaned against the inner surface of the tank by the pressurized fluid,
the second section fits the opening and
a gasket of diameter D₂ larger than the opening diameter D₀ is placed on the second boss section.

In the present description of the invention, the term “boss seal” is used to describe a specific plug mechanism used to seal a tank opening. The boss seal described in this invention comprises two sections, namely the first boss section and the second boss section.

The first boss section is the section of the boss seal that has a diameter D₁ bigger than the opening diameter D₀. The second boss section is in contact with the inner surface of the tank A₁, the inner surface of the tank A₁ being the surface in contact with the contained fluid, and the second boss section may, in some embodiments, be in contact with a shoulder.

The second boss section is the section of the boss seal that has the same diameter than the opening (Do). When the opening is sealed, the first boss section is the outer part of the boss seal, that is farthest to the contained fluid.

Having a second boss section larger than the opening would spread the load exerted by the pressurized fluid on the boss seal over a large surface. The boss seal would be placed inside the tooling before the production stage of the tank as the boss seal is larger than the opening and couldn't be inserted in the tank after production.

In the present description of the invention, the term “gasket” refers to a piece of soft, rubber, composite, elastomer, plastic, polytetrafluoroethylene, or thermoplastic material, that is put over the first boss section in order to prevent any fluid to escape from the tank.

The tank may also be characterised in that the first and second boss seal sections are separated into two distinct parts fitting each other. These two sections would be locked and assembled into each other when the opening needs to be sealed, namely a separate first boss section part and a separate second section part. Having two separate section parts would therefore ease the closing process. The separate first boss section part would be placed inside the tank before the tank's production stage as the first boss section is larger than the opening.

The separate first boss section part may be made up of at least two subparts, the subparts having a length smaller to the diameter D₀ allowing these subparts to pass through the opening. Having at least two first boss section subparts would make the insertion of the separate first boss section part possible after producing the tank. Increasing the number of first boss section subparts will thus ease the setting up of the boss seal. The at least two first boss section subparts may hold together by means of design (e.g. an interlocking mechanism), so too by being pushed towards the inner surface of the tank at the opening by the contained pressurized fluid.

In the present description of the invention, the term “shoulder” is used to describe a circular reinforcement thickening a tank opening. This shoulder may also have a cylindrical top section to act as an opening collar. Such a shoulder is usually moulded to the tank around an opening.

In the present description of the invention, the term “tank shell” is used and refers to the basic hard structure of the tank.

The tank's inner surface A₁ at the opening may also have a moulded shoulder. Such a shoulder would increase the tank's shell thickness at the opening, making it more stress and strain resistant. The shoulder may be made with reinforced continuous fibres, long, short or without reinforcement and different from the reinforcement wound to make the tank. It can be a separated ring or included in the tank skin. This ring may be made of a technical polymer or metallic. Preferably the shoulder is made of the same resin as the tank.

The boss seal may be made from metal, overmoulded metal or plastic reinforced metal. The plastic part or overmould is preferably made of short fibres. The boss seal material will depend on different variables such as the stored fluid, the working temperature, the pressure, . . . . The metal used would preferably be corrosion resistant in the case where the metal is not overmoulded.

In the present description of the invention, the term “overmoulded metallic part” refers to a metallic part covered in a material different than metal (e.g. thermoplastic materials) to protect the metal from contact with the contained fluid (as an example, it may protect the metal from corrosion).

The tank may be made of a composite material mixing fibre and resin, with the inner surface of the tank being a separate polymer liner. This type of tank is commonly referred to as a “type IV” vessel. Type IV vessels are made with a fibre composite filament wound put over a thermoplastic polymer liner.

Alternatively, the inner surface of the tank may be a homogeneous liner made from the same resin as the tank. This type of tank is commonly referred to as a “type V” vessel. Type V vessels are made with a fibre composite filament wound with the same resin used for the tank as a liner, making the vessel more homogeneous. Alternatively, type V vessels may not have any liners.

In the present description of the invention, the term “liner” is used to describe the part on the inner surface of the tank that guarantees the tightness of the tank. Depending on the type of tank, a liner can be made of either a different material than the tank (e.g. a thermoplastic polymer) or the same resin as the tank. Some tanks may not have any liner.

A gasket of diameter D₂ larger than the opening diameter D₀ is placed over the second section of the boss seal. This gasket is compatible with the stored fluid and is used to make the tank tight by pushing towards the opening wall.

A groove may be put on the second boss section to fit the gasket and to compress the gasket. The gasket will ensure tightness and may ensure the process to be isochoric.

A spring retaining ring may be placed at the tank's opening. It is meant by “spring retaining ring”, a multi-turn, spiral wound retaining ring consisting of a flat wire material with rounded edges, coiled on edge to provide a gapless ring with 360 degrees of retention.

In the present description of the invention, the term “tank's inner surface” is used to describe the surface of the tank that is in the interior of the tank, surface that is in contact with the contained fluid.

### LIST OF FIGURES

The invention is further elucidated in the appending figures and figure description explaining preferred embodiments of the invention. Note that the figures are not drawn to scale. The figures are intended to describe the principles of the invention.

FIG. 1 is a sectional view of a first embodiment being a tank's sealing apparatus being made of a single boss seal.

FIG. 2 is an exploded view of a second embodiment, the tank's sealing apparatus being made of two separate boss section parts, having an individual first boss section.

FIG. 3 is a sectional view of the FIG. 2.

FIG. 4 is an exploded view of a third embodiment, the tank's sealing apparatus being made of two separate boss section parts, the first boss section being divided into two subparts.

FIG. 5 is a sectional view of FIG. 4.

### DESCRIPTION OF THE DRAWINGS

Unless stated otherwise, a same element appearing on different figures presents a single reference.

Furthermore, the terms “first”, “second”, and the like in the description and in the claims, are used for distinguishing between similar elements and not necessarily for describing a sequential or chronological order.

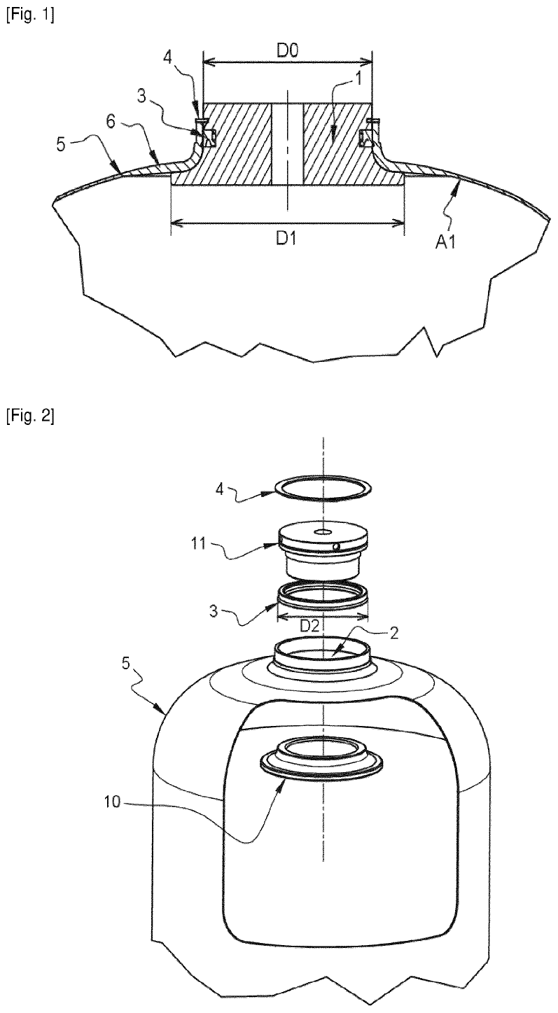

A first embodiment of the invention is a fibre composite cylindrical tank 5 containing a pressurized fluid, having at least one opening 2 with diameter D₀, and having an inner surface A₁, sealed by a boss seal 1. This first embodiment is shown on FIG. 1.

A shoulder 6 consisting of a circular reinforcement thickening the tank 5 opening 2 is used as a reinforcement. This shoulder 6 may also have a cylindrical top section to act as an opening collar. Such a shoulder is usually moulded to the tank around the opening 2.

The boss seal 1 comprising a first boss section with diameter D₁ larger than the opening diameter D₀ and a second boss section with diameter D₀ equal to the opening diameter D₀.

A gasket 3 is placed on the second boss section to prevent any leaks and to ensure tightness.

A spring retaining ring 4 is placed over the second boss section to hold the boss seal 1 at the opening 2 when the tank is empty (i.e. when the boss seal 1 is not held up by pressurized fluid).

The first boss section is leaned against the inner surface of the tank by the contained pressurized fluid, and on the moulded shoulder 6. As the first boss section has a diameter D₁ larger than the opening diameter D₀, the first boss section would not pass through the opening 2 and would remain in place and would therefore seal the tank opening 2.

The second boss section is plugged in the tank's opening 2 and is the outer part of the boss seal 1, that is farthest to the contained fluid.

The boss seal 1 may have at least one opening allowing devices to be inserted. As an example, a gauge, pipe, or catalyser can be put in that opening.

The tank 5 is identified in that it is made of a composite wound. Such a tank can be obtained by rotor-moulding or blow-moulding. The tank 5 is therefore produced over a mould.

The boss seal 1 comprising the first boss section and second boss section is put in the tank with the mould tooling before the tank's production. The boss seal part 1 is placed with the production tooling (mould) before the start of the production stage in order to place and keep the boss seal part 1 inside the tank 5 when it is produced. Indeed, after production, the boss seal part 1 would remain inside the tank 5.

The pressurized fluid contained in the tank 5 may, for example, be a gas, a liquid, a mix of gas and liquid or a mix of liquid and solid.

In a second embodiment, the first boss section 10 and the second boss section 11 are two separate boss parts fitting each other. As the diameter of the separate first boss section part 10 is bigger than the opening 2, the separate first boss section part 10 would be put inside the tank before production, as it is the case in the first embodiment, whereas the separate second boss section part 11 may be inserted when needed as the separate second boss section part 11 can pass through the opening 2.

FIG. 2 is an exploded view of the apparatus where the first boss section 10 and the second boss section 11 are two separate parts.

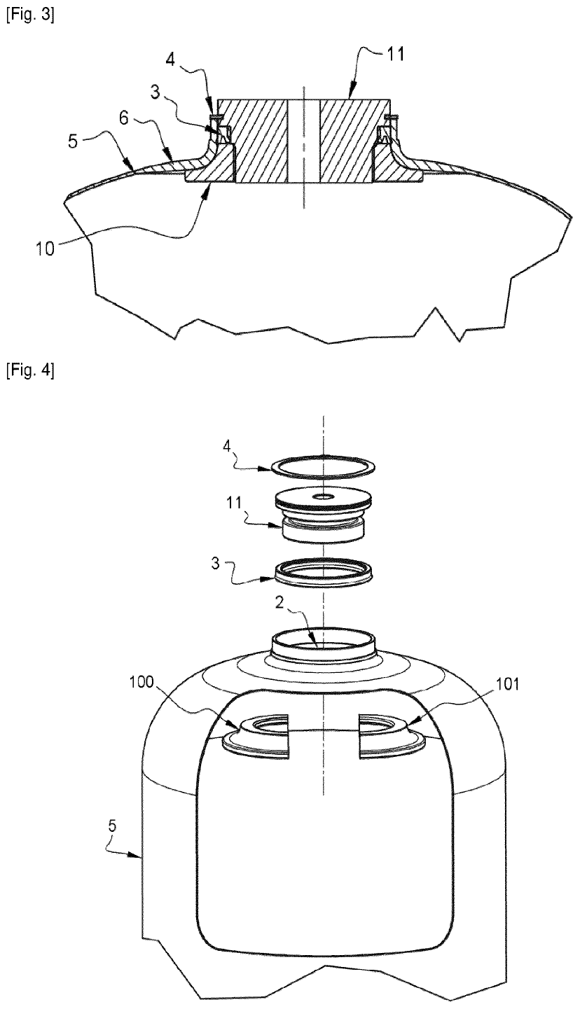

FIG. 3 shows the same embodiment as the one presented on FIG. 2, with the assembled boss seal parts.

In this second embodiment, the separate first boss section part 10 is placed with the production tooling (i.e. mould) when the filament wound is done to produce the cylindrical tank 5. Similarly to the boss seal part 1 placement in the first embodiment, the separate first boss section part 10 would remain inside the tank 5 after the production stage of said tank 5. The separate second boss section part 11 however may be introduced later as it has a diameter D₀ equal to the opening diameter.

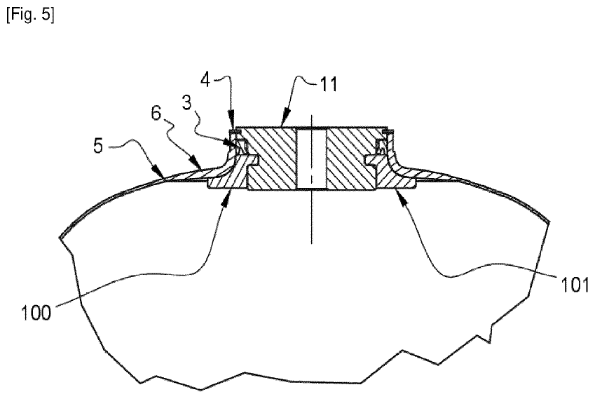

In a third embodiment where the first boss section 10 and the second boss section 11 are separate parts, the separate first boss section part 10 may be made of at least two subparts 100 and 101 allowing a more convenient insertion of the boss seal, as shown on FIG. 4 and FIG. 5.

Having two subparts 100 and 101 allows for an even easier set up as no boss seal apparatus needs to be inserted with the tooling during the production stage as the subparts 100 and 101 can pass through the opening 2 and be inserted at any time. Indeed, the subparts 100 and 101 having a length smaller to the diameter D₀ make the insertion and passing through of these subparts 100 and 101 in the opening 2 feasible.

FIG. 4 and FIG. 5 show this third embodiment, with two first section subparts 100 and 101. The number of first boss section subparts is not limited to two, but having two subparts is a preferred embodiment.

For the first embodiment described above and shown on FIG. 1, the sealing process is performed by taking the boss seal part 1 from inside the tank and placing it at the opening 2.

For the second embodiment described above and shown on FIGS. 2 and 3, the sealing process is performed by taking the separate first boss section part 10 from inside the tank and interlocking it with the separate second boss section part 11, placing the complete boss seal at the opening 2. The separate second boss section part 11 may be out of the tank 5 prior to the tank's sealing.

For the third embodiment described above and shown on FIGS. 4 and 5, the sealing process is performed by firstly inserting the at least two first boss section subparts 100 and 101 into the tank 5 if these subparts weren't inside the tank 5, then assembling these subparts together, and finally interlocking the assembled separate first boss section part 10 with the separate second boss section part 11, placing the complete boss seal at the opening 2. The separate second boss section part 11 as well as the at least two first section subparts may be out of the tank 5 prior to the tank's sealing.

For all three embodiments mentioned, the boss seal remains at the opening 2 by means of either the pressurized fluid contained in the tank 5 or the spring retaining ring 4.

Although the invention relates to cylindrical pressure tanks, these tanks may alternatively be polymorph or toroid shaped.

While the invention has been described in conjunction with specific embodiments thereof, it is important to note that combinations of embodiments is feasible and may be considered.

1. A fibre composite cylindrical tank for containing a pressurized fluid, having at least one opening with an opening diameter D₀, and having an inner surface A₁, sealed by a boss seal, wherein the boss seal comprises:
a first boss section with diameter D₁ larger than the opening diameter D₀ and
a second boss section of diameter D₀ equal to the opening diameter D₀,
and wherein
the first boss section is leaned against the inner surface of the fibre composite cylindrical tank by the pressurized fluid,
the second boss section fits the opening and
a gasket of diameter D₂ larger than the opening diameter D₀ is placed on the second boss section, and
the first and second boss sections are separated into two distinct parts fitting each other.

2. The fibre composite cylindrical tank according to claim 1, wherein the first boss section is made up of at least two subparts, the at least two subparts having its larger dimension smaller than the diameter D₀ allowing these at least two subparts to pass through the opening.

3. The fibre composite cylindrical tank according to claim 1, wherein the inner surface A₁ at the opening has a moulded shoulder.

4. The fibre composite cylindrical tank according to claim 1, wherein the boss seal is a metallic or overmolded metallic part.

5. The fibre composite cylindrical tank according to claim 1, wherein the tank is made of a composite material mixing fibre and resin, with the inner surface of the tank being a separate polymer liner.

6. The fibre composite cylindrical tank according to claim 1, wherein the fibre composite cylindrical tank is made of a composite material mixing fibre and resin, having either the inner surface of the fibre composite cylindrical tank being a homogeneous liner made from the same resin as the fibre composite cylindrical tank or no liner at all.

7. The fibre composite cylindrical tank according to claim 1, wherein the second boss section has a groove fitting the gasket-.

8. The fibre composite cylindrical tank according to claim 1, wherein the fibre composite cylindrical tank is wound by a fibre composite.

9. The fibre composite cylindrical tank according to claim 1, wherein the fibre composite cylindrical tank is for containing a pressurized fluid.
